(19) United States
(12) Patent Application Publication
(10) Pub. No.: US 2007/0295757 A1
(43) Pub. Date: Dec. 27, 2007

(54) TRIGGER SPRAYER NOZZLE ASSEMBLY AND SPRAYER HOUSING ATTACHMENT LOCK

(75) Inventors: Donald D. Foster, St. Charles, MO (US); Philip L. Nelson, Wildwood, MO (US); Walter J. Clynes, O'Fallon, MO (US)

Correspondence Address: THOMPSON COBURN, LLP, ONE US BANK PLAZA, SUITE 3500, ST LOUIS, MO, 63101, US

(73) Assignee: CONTINENTALAFA DISPENSING COMPANY, St. Peters, MO (US)

(21) Appl. No.: 11/851,948

(22) Filed: Sep. 7, 2007

Related U.S. Application Data
(63) Continuation-in-part of application No. 11/369,351, filed on Mar. 7, 2006.
(63) Continuation-in-part of application No. 11/613,706, filed on Dec. 20, 2006.

(51) Int. Cl. B65D 88/54; B67D 5/40

(52) U.S. Cl. 222/340; 222/383.1

(57) ABSTRACT

The present invention pertains to the construction of a manually operated trigger sprayer in which the sprayer housing has a reduced diameter dimension liquid discharge passage to increase the velocity of liquid flow through the liquid discharge passage, and in which the nozzle assembly has a novel configuration that securely attaches the nozzle assembly to the sprayer housing to prevent the increased velocity of liquid flow through the sprayer housing liquid discharge passage from dislodging the nozzle assembly from the sprayer housing. The novel construction of the sprayer housing and the nozzle assembly includes a resilient crossbar provided on the sprayer housing that crosses over the liquid discharge passage and a pair of resilient flanges on the nozzle assembly that engage over opposite sides of the sprayer assembly crossbar and securely attaching the nozzle assembly to the sprayer housing.

### CROSS-REFERENCE TO RELATED APPLICATIONS

This is a continuation-in-part of patent application Ser. No. 11/369,351, filed on Mar. 7, 2006, and currently pending, and a continuation-in-part of patent application Ser. No. 11/613,706, filed Dec. 20, 2006 and currently pending.

### BACKGROUND OF THE INVENTION

1. Field of the Invention

The present invention pertains to the construction of a manually operated trigger sprayer in which the sprayer housing has a reduced diameter dimension liquid discharge passage to increase the velocity of liquid flow through the liquid discharge passage, and in which the nozzle assembly has a novel configuration that securely attaches the nozzle assembly to the sprayer housing to prevent the increased velocity of liquid flow through the sprayer housing liquid discharge passage from dislodging the nozzle assembly from the sprayer housing. The novel construction of the sprayer housing and the nozzle assembly includes a resilient crossbar provided on the sprayer housing that crosses over the liquid discharge passage and a pair of resilient flanges on the nozzle assembly that engage over opposite sides of the sprayer housing crossbar in securely attaching the nozzle assembly to the sprayer housing.

2. Description of the Related Art

Handheld and hand pumped liquid dispensers commonly known as trigger sprayers are used to dispense many household products and commercial cleaners. Trigger sprayers have been used to dispense household cleaning or cooking liquids and have been designed to selectively dispense the liquids in a spray, stream, or foaming discharge. The trigger sprayer is typically connected to a plastic bottle that contains the liquid dispensed by the sprayer.

A typical trigger sprayer includes a sprayer housing that is connected to the neck of the bottle by either a thread connection or a bayonet-type connection. The sprayer housing is formed with a pump chamber and a vent chamber, a liquid supply passage that communicates the pump chamber with a liquid inlet opening of the sprayer housing, and a liquid discharge passage that communicates the pump chamber with a liquid outlet opening of the sprayer housing. A dip tube is connected to the sprayer housing liquid inlet opening to communicate the pump chamber with the liquid contents of the bottle connected to the trigger sprayer.

A nozzle assembly is connected to the sprayer housing at the liquid outlet opening. Some nozzle assemblies include a nozzle cap that is rotatable relative to the sprayer housing between an “off” position where liquid discharge from the trigger sprayer is prevented, and one or more “on” positions where liquid discharge from the trigger sprayer is permitted. In addition, known nozzle assemblies can affect the liquid discharged by the trigger sprayer to discharge the liquid in a spray pattern, in a stream pattern, or as a foam.

A pump piston is mounted in the sprayer housing pump chamber for reciprocating movement between charge and discharge positions of the piston relative to the pump chamber. When the pump piston is moved to its charge position, the piston is retracted out of the pump chamber. This creates a vacuum in the pump chamber that draws liquid from the bottle, through the dip tube and into the pump chamber. When the pump piston is moved to its discharge position, the piston is moved into the pump chamber. This exerts a force on the liquid in the pump chamber that pumps the liquid from the pump chamber, through the liquid discharge passage of the sprayer housing and out of the trigger sprayer through the nozzle assembly.

A trigger is mounted on the sprayer housing for movement of the trigger relative to the housing. The trigger is operatively connected to the pump piston to cause the reciprocating movement of the pump piston in the pump chamber in response to movement of the trigger. A user's hand squeezes the trigger toward the sprayer housing to move the trigger and move the pump piston toward the discharge position of the piston in the pump chamber. A metal coil spring is typically positioned inside the pump chamber. The spring engages between the pump piston and a surface of the sprayer housing inside the pump chamber. The spring is compressed when the pump piston is moved to the discharge position in the pump chamber. The resilience of the spring pushes the piston back to the discharge position of the piston relative to the pump chamber when the user's squeezing force on the trigger is released.

Inlet and outlet check valves are assembled into the respective liquid supply passage and liquid discharge passage of the trigger sprayer. The check valves control the flow of liquid from the bottle interior volume through the liquid supply passage and into the pump chamber, and then from the pump chamber and through the liquid discharge passage to the nozzle assembly of the trigger sprayer.

Trigger sprayers that produce a quick and forceful discharge of liquid from the nozzle assembly each time the trigger is manually squeezed are more desirable to consumers than trigger sprayers that have a weak discharge of liquid. However, designing a trigger sprayer with a quick and forceful discharge of liquid from the trigger sprayer presents the problem of maintaining the nozzle assembly on the sprayer housing of the trigger sprayer when it is subjected to the quick and forceful discharge of liquid from the sprayer housing.

### SUMMARY OF THE INVENTION

The trigger sprayer of the present invention provides the advantage of producing a quick and forceful discharge of liquid from the trigger sprayer without presenting the potential problem of the nozzle assembly being dislodged from the sprayer housing of the trigger sprayer. This is achieved by providing a sprayer housing with a liquid discharge passage that has a reduced diameter dimension from that of prior art trigger sprayers. The reduced diameter dimension of the liquid discharge passage accelerates the flow of liquid through the liquid discharge passage. In addition, the sprayer housing includes additional features that securely hold the nozzle assembly to the sprayer housing when the nozzle assembly is subjected to the quick and forceful discharge of liquid from the liquid discharge passage.

The trigger sprayer of the invention has a sprayer housing construction that is similar to that of prior art trigger sprayers. The sprayer housing basically includes an integral cap that attaches to the neck of a separate bottle that contains the liquid to be dispensed by the trigger sprayer. A liquid inlet opening is provided on the sprayer housing inside the cap, and a liquid supply passage extends upwardly through the sprayer housing from the liquid inlet opening.

The sprayer housing also includes a pump chamber having a cylindrical pump chamber wall. The pump chamber communicates with the liquid supply passage.

A liquid discharge passage extends through a liquid discharge tube on the sprayer housing. The liquid discharge passage communicates the pump chamber with a liquid outlet opening on the sprayer housing. The liquid discharge tube has an elongate and narrow configuration. This results in the liquid discharge passage that extends through the liquid discharge tube having a smaller cross-sectional area than the liquid discharge passage of a prior art trigger sprayer. This reduction in the cross-sectional area of the liquid discharge passage increases the velocity of liquid flow through the liquid discharge passage on manual actuation of the pump.

The sprayer housing is provided with a pair of side walls that extend along the opposite sides of the liquid discharge tube. A cross-brace extends across and connects to the sprayer housing side walls. The cross-brace is positioned adjacent the distal end of the liquid discharge tube. A catch projects from a surface of the cross-brace.

A valve assembly is inserted into the liquid supply passage and separates the liquid supply passage from the liquid discharge passage. The valve assembly includes an input valve that controls the flow of liquid from the sprayer housing inlet opening to the pump chamber, and an output valve that controls the flow of liquid from the pump chamber and through the liquid discharge passage to the liquid outlet opening.

A valve plug assembly is assembled into the liquid supply passage of the sprayer housing. The valve plug assembly includes a valve seat that seats against the input valve, and a vent baffle that defines a vent air flow path through the pump chamber to the interior of the bottle attached to the trigger sprayer.

A nozzle assembly is assembled to the trigger sprayer at the sprayer housing liquid outlet opening. The nozzle assembly is rotatable relative to the trigger sprayer to close the liquid flow path through the liquid discharge passage and the liquid outlet opening, and to open the liquid flow path through the liquid discharge passage and the outlet opening. The nozzle assembly has several open positions relative to the sprayer housing that enable the selective discharge of a liquid in a stream pattern, a spray pattern, and a foaming discharge.

The novel construction of the nozzle assembly includes a pair of resilient flanges that project in the rearward direction from the nozzle assembly. The pair of flanges are spaced from each other and one flange extends over the sprayer housing crossbar and the second flange extends beneath the sprayer housing crossbar. Alternatively, a pair of second flanges could extend beneath the sprayer housing crossbar. The first flange has a hole that receives the catch projecting from the sprayer housing crossbar in attaching the nozzle assembly to the sprayer housing. The second flange has a hook configuration at a distal end of the flange that engages across a back edge of the sprayer housing crossbar in securely attaching the nozzle assembly to the sprayer housing. By providing the nozzle assembly with both the first and second flanges that engage over opposite surfaces of the sprayer housing crossbar, the novel construction of the nozzle assembly and the sprayer housing securely attaches the nozzle assembly to the sprayer housing.

A piston assembly is mounted in the pump chamber for reciprocating movements between charge and discharge positions of the piston assembly relative to the sprayer housing. The piston assembly includes a pump piston and a vent piston, both mounted in the pump chamber. As the pump piston moves to its charge position, the vent piston is moved to a closed position where a venting air flow path through the pump chamber and through the venting air baffle is closed. As the pump piston is moved to its discharge position, the vent piston is moved to an open position in the pump chamber. This opens the venting air flow path through the pump chamber and the venting air baffle to the interior volume of the bottle attached to the trigger sprayer.

A manually operated trigger is mounted on the sprayer housing for pivoting movement. The trigger is engaged by the fingers of a user's hand holding the trigger sprayer. Squeezing the trigger causes the trigger to move toward the pump chamber, and releasing the squeezing force on the trigger allows the trigger to move away from the pump chamber. The trigger is provided with a pair of flanges that engage with the sprayer housing when the trigger is moved to its forward-most position relative to the sprayer housing, preventing further forward movement of the trigger.

The trigger sprayer includes a piston rod that is operatively connected between the trigger and the pump piston. The piston rod has a length with a first, forward end and an opposite second, rearward end. The first, forward end of the piston rod is operatively connected to the trigger. The second, rearward end of the piston rod is operatively connected to the piston assembly. The piston rod rearward end is formed integrally with the piston assembly. As the piston rod length extends forwardly from the piston assembly, the piston rod length has a necked down portion with a first, circumferential dimension. The piston rod length then extends to an enlarged portion in the form of a knob at the forward end of the piston rod. The knob at the forward end has a second circumferential dimension that is larger than the first circumferential dimension of the necked down section. The forward knob of the piston rod is also compressible. In the preferred embodiment, a vertical groove is formed into the first end of the piston rod to enable compression of the first end.

A plastic spring that is assembled to the trigger sprayer outside of the pump chamber. The plastic spring has a curved or bent length with opposite forward and rearward ends. The rearward end of the spring has a curved bar. The curved bar presents a curved surface that engages across a portion of the cylindrical exterior surface of the pump chamber in assembling the spring to the trigger sprayer. From the spring rearward end the spring length has two portions that extend side-by-side over the pump chamber exterior surface and then through inverted U-shaped bends. The forward ends of the bent portions of the springs are connected together by a front panel at the forward ends of the springs. The front panel has an opening through the panel. The piston rod forward end extends through the panel opening. This operatively connects the pair of springs to the piston rod and the piston assembly for biasing the piston rod and piston assembly in a forward direction to the charge position of the piston assembly in the pump chamber. The bias of the pair of springs also urges the trigger toward a forward position of the trigger relative to the trigger sprayer.

The U-shaped configurations of the springs bias the piston rod away from the pump chamber. This biases the piston assembly toward its charge position relative to the pump chamber and the sprayer housing. By manually squeezing the trigger of the trigger sprayer, the forward ends of the springs are moved toward the rearward ends of the springs, narrowing the U-shaped configurations of the springs. When the squeezing force on the trigger is removed, the resiliency of the springs pushes the trigger away from the pump chamber and moves the pump piston back to its charge position relative to the pump chamber.

Thus, the novel construction of the sprayer housing includes a reduced cross-section area dimension of the liquid discharge passage that increases the velocity of liquid pumped through the liquid discharge tube. This increased velocity of liquid discharge from the sprayer housing provides the quick and forceful ejection of liquid from the sprayer housing desired by consumers.

In addition, by providing the novel construction of the crossbar on the sprayer housing combined with the flanges that project from the nozzle assembly and engage over opposite surfaces of the crossbar to securely attach the nozzle assembly to the sprayer housing, the potential problem of the quick and forceful ejection of liquid from the sprayer housing potentially pushing off the nozzle assembly from the sprayer housing is eliminated.

### DESCRIPTION OF THE DRAWING FIGURES

Further features of the invention are set forth in the following detailed description of the preferred embodiment of the invention and in the drawing figures.

FIG. 1 is a side sectioned view of the trigger sprayer of the invention with the trigger in a forward position relative to the sprayer housing.

FIG. 2 is a perspective view of the disassembled component parts of the trigger sprayer.

FIG. 3 is a top view of the trigger sprayer with the shroud removed.

FIG. 4 is a side sectioned view of the trigger sprayer along the line 4-4 of FIG. 3 and with the trigger in a rearward position relative to the sprayer housing.

FIG. 5 is a side sectioned view of a further embodiment of the trigger sprayer of the invention that employs a different trigger, spring, and piston rod construction from those of the previously described embodiment.

FIG. 6 is a side sectioned view of the trigger, spring, and piston rod removed from the sprayer housing of FIG. 5.

FIG. 7 is a perspective view of the component parts of the trigger sprayer of FIG. 5 disassembled.

FIG. 8 is a perspective view of the spring and piston rod of FIG. 5.

FIG. 9 is a perspective view of a slightly different embodiment of the attachment lock with the nozzle assembly separated from the sprayer housing.

FIG. 10 is a perspective view of the embodiment of FIG. 9 showing the nozzle assembly locked to the sprayer housing.

FIG. 11 is a partial, enlarged view of the circled area of FIG. 10.

### DETAILED DESCRIPTION OF THE PREFERRED EMBODIMENT

Several component parts of the trigger sprayer of the invention are found in the typical construction of a trigger sprayer, and therefore these component parts are described only generally herein. It should be understood that although the component parts are shown in the drawing figures and are described as having a certain construction, other equivalent constructions of the component parts are known. These other equivalent constructions of trigger sprayer component parts are equally well suited for use with the novel features of the invention to be described herein.

The trigger sprayer includes a sprayer housing 12 that is formed integrally with a connector cap 14. The connector cap 14 removably attaches the trigger sprayer to the neck of a bottle containing the liquid to be dispensed by the trigger sprayer. The connector cap 14 shown in the drawing figures has a bayonet-type connector on its interior. Other types of equivalent connectors may be employed in attaching the trigger sprayer to a bottle. A liquid inlet opening 16 is provided on the sprayer housing 12 in the interior of the connector cap 14. The inlet opening 16 provides access to a liquid supply passage 18 that extends upwardly through a cylindrical liquid column 22 formed in the sprayer housing 12. The column 22 has a center axis 24 that is also the center axis of the liquid supply passage 18. An air vent opening 26 is also provided on the sprayer housing 12 in the interior of the connector cap 14. A cylindrical sealing rim 28 projects outwardly from the connector cap interior and extends around the liquid inlet opening 16 and the vent opening 26. The rim 28 engages inside the neck of a bottle connected to the trigger sprayer to seal the connection.

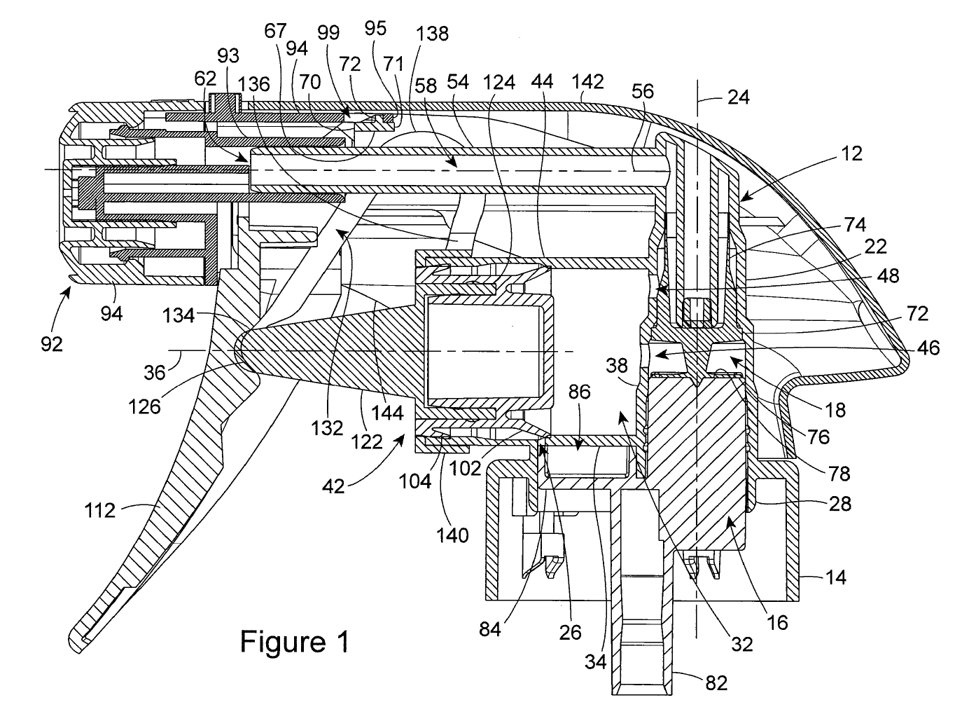

The sprayer housing includes a pump chamber 32 contained inside a cylindrical pump chamber wall 34 on the sprayer housing 12. The pump chamber cylindrical wall 34 has a center axis 36 that is perpendicular to the liquid supply passage center axis 24. The pump chamber center axis 36 defines mutually perpendicular axial and radial directions relative to the trigger sprayer. To the left in FIG. 1 is a forward axial direction relative to the sprayer housing 12, and to the right in FIG. 1 is a rearward axial direction relative to the sprayer housing 12. A cylindrical interior surface of the pump chamber wall 34 has a smaller interior diameter section adjacent a rear wall 38 of the pump chamber, and a larger interior diameter section adjacent an end opening 42 of the pump chamber. The pump chamber also has a cylindrical exterior surface 44. The smaller interior diameter portion of the pump chamber 32 interior surface functions as the liquid pump chamber, and the larger interior diameter portion of the pump chamber 32 functions as a portion of a venting air flow path through the sprayer housing 12. The vent opening 26 in the sprayer housing connector cap 14 communicates the interior of the larger interior diameter portion of the pump chamber 32 with a bottle connected to the trigger sprayer. A pair of openings 46, 48 pass through the pump chamber rear wall 38 and communicate the interior of the pump chamber with the liquid supply passage 18. The first of the openings 46 is the liquid input opening to the pump chamber 32, and the second of the openings 48 is the liquid output opening from the pump chamber.

A liquid discharge tube 54 is also formed on the sprayer housing 12. The liquid discharge tube is cylindrical and has a center axis 56 that is parallel with the pump chamber center axis 36. The liquid discharge tube 54 defines the liquid discharge passage 58 of the sprayer housing. One end of the liquid discharge passage 58 communicates with the liquid supply passage 18 in the liquid column 22, and the opposite end of the liquid discharge passage 58 exits the sprayer housing 12 through a liquid outlet opening 62 on the sprayer housing. The liquid discharge tube 54 is given a narrow elongate configuration. This reduces the interior cross-section diameter dimension of the liquid discharge passage 58 extending through the liquid discharge tube 54. The reduction in the interior diameter dimension of the liquid discharge passage 58 results in an increase in the velocity of liquid pumped through the liquid discharge passage 58 on operation of the trigger sprayer. This increase in velocity of the liquid passing through the liquid discharge passage 58 provides a quick and forceful ejection of liquid from the liquid discharge passage 58 that is desired by consumers.

The sprayer housing 12 is also formed with a pair of exterior side walls or side panels 64 that extend over opposite sides of the pump chamber wall 34 and over opposite sides of the discharge tube 54. The side walls 64 extend over the pump chamber wall 34 in the area of the pump chamber rear wall 38, but do not extend in the forward direction the full extent of the pump chamber wall 34 to the end opening 42. The side walls 64 are spaced outwardly from the pump chamber wall 34 and the discharge tube 54 forming voids 66 between the side wall 64 and the pump chamber wall 34 and the discharge tube 54. The side walls 64 have lengths on the opposite sides of the liquid discharge tube 54 that extend substantially the entire length of the discharge tube.

The novel construction of the sprayer housing 12 includes a crossbar 67 that extends between the two housing side walls 64. The crossbar 67 is connected to the two side walls 64 and is spaced from the discharge tube 54. The crossbar 67 has the configuration of a thin strip with opposite first 68 and second 69 surfaces, and opposite front 70 and back 71 edges. The thin strip configuration of the crossbar 67 allows it to resiliently flex toward and away from the discharge tube 54. A catch 72 is formed on the first surface 68 of the crossbar. The catch 72 has a wedge-shaped configuration that projects outwardly from the crossbar first surface 68. The wedge-shaped configuration of the catch 72 presents a tapered surface toward the crossbar front edge 70 and a flat surface that is perpendicular to the crossbar first surface 68 adjacent the crossbar back edge 71.

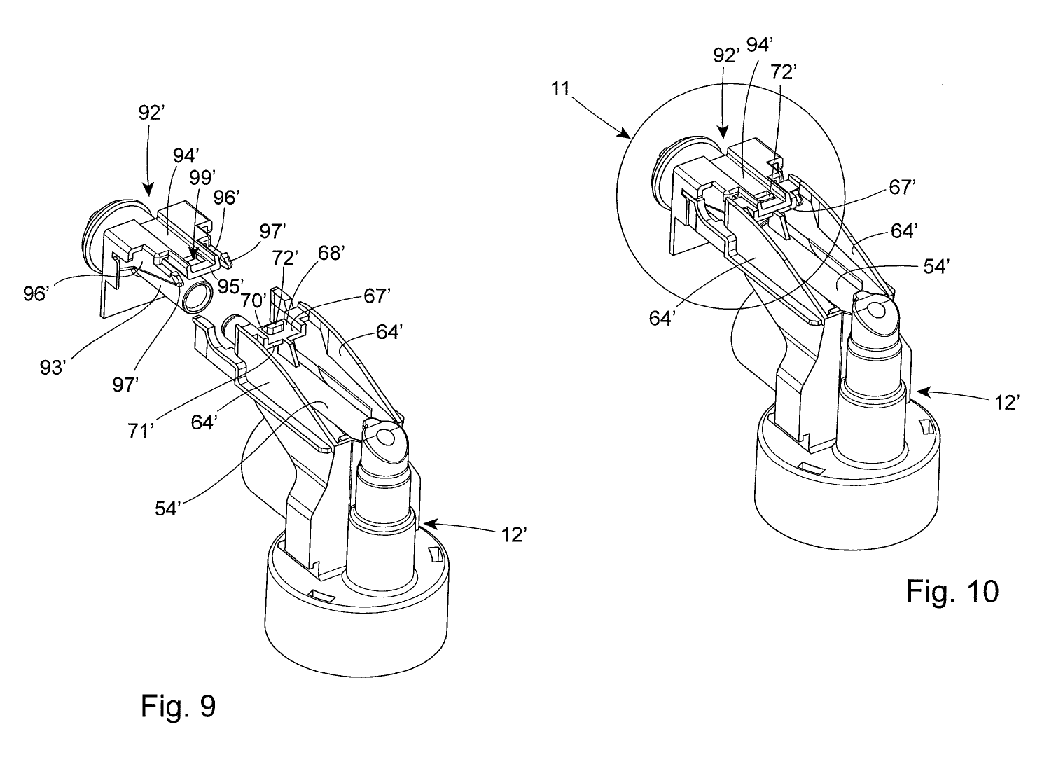

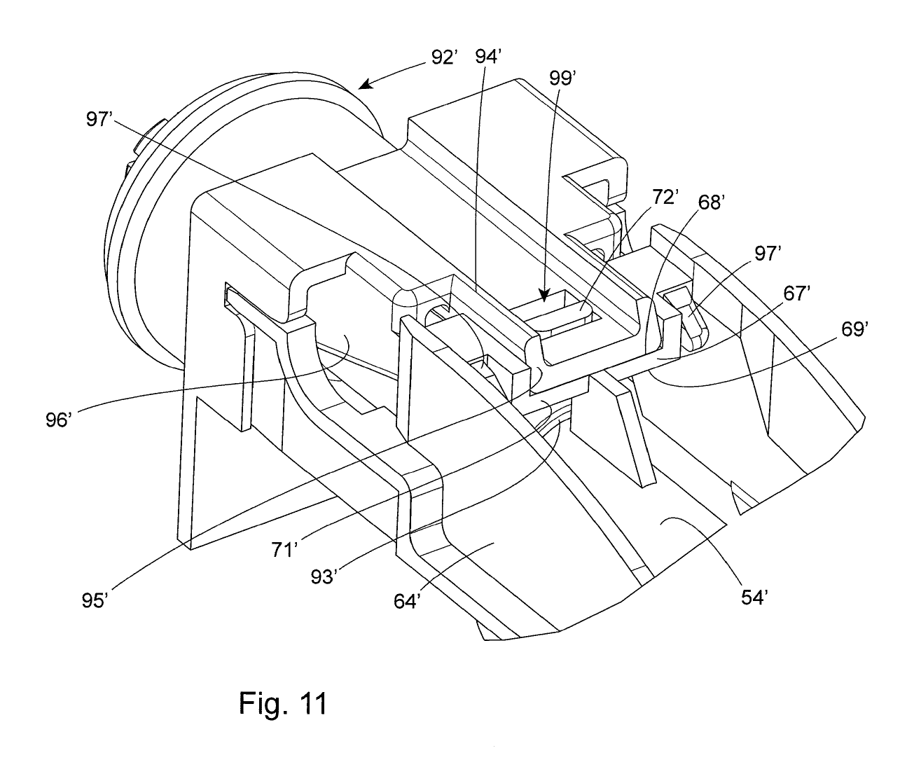

FIGS. 9-11 show a slightly different embodiment of the sprayer housing 12′ with the component parts of the sprayer housing described above being labeled with the same reference numbers used above, but with the reference numbers being followed by a prime (′).

A valve assembly comprising an intermediate plug 73, a resilient sleeve valve 74 and a resilient disk valve 76 is assembled into the liquid supply passage 18. The valve assembly is inserted through the liquid inlet opening 16 and the valve assembly plug 73 seats tightly in the liquid supply passage 18 between the pump chamber input opening 46 and the pump chamber output opening 48. Thus, the plug 73 separates the liquid inlet opening 16 into the pump chamber 32 from the liquid outlet opening 62 from the pump chamber 32. The disk valve 76 is positioned in the liquid supply passage 18 to control the flow of liquid from the liquid inlet opening 16 into the pump chamber 32, and to prevent the reverse flow of liquid. The sleeve valve 74 is positioned to control the flow of liquid from the pump chamber 32 and through the liquid discharge passage 58 and the liquid outlet opening 62, and to prevent the reverse flow of liquid.

A valve plug assembly comprising a valve seat 78, a dip tube connector 82, and an air vent baffle 84 is assembled into the liquid inlet opening 16 inside the connector cap 14. The valve seat 78 is cylindrical and seats against the outer perimeter of the valve assembly disk valve 76. A hollow interior bore of the valve seat 78 allows liquid to flow through the bore and unseat the disk valve 76 from the seat 78 as the liquid flows from the inlet opening 16 to the pump chamber 32. The periphery of the disk valve 76 seats against the valve seat 78 to prevent the reverse flow of liquid. The dip tube connector 82 is a cylindrical connector at the center of the plug assembly that connects to a separate dip tube (not shown). The valve plug assembly positions the dip tube connector 82 so that it is centered in the connector cap 14 of the sprayer housing. The air vent baffle 84 covers over but is spaced from the vent opening 26 in the connector cap 14. The baffle 84 has a baffle opening 86 that is not aligned with the vent opening 26, but communicates with the vent opening through the spacing between the air vent baffle 84 and the interior surface of the connector cap 14. This allows air to pass through the vent opening 26 and through the baffle spacing and the baffle opening 86 to vent the interior of the bottle connected to the trigger sprayer to the exterior environment of the sprayer. Because the vent opening 26 and baffle opening 86 are not directly aligned, the air vent baffle 84 prevents liquid in the bottle from inadvertently passing through the baffle opening 86, the baffle spacing and the vent opening 26 to the exterior of the trigger sprayer should the trigger sprayer and bottle be inverted or positioned on their sides.

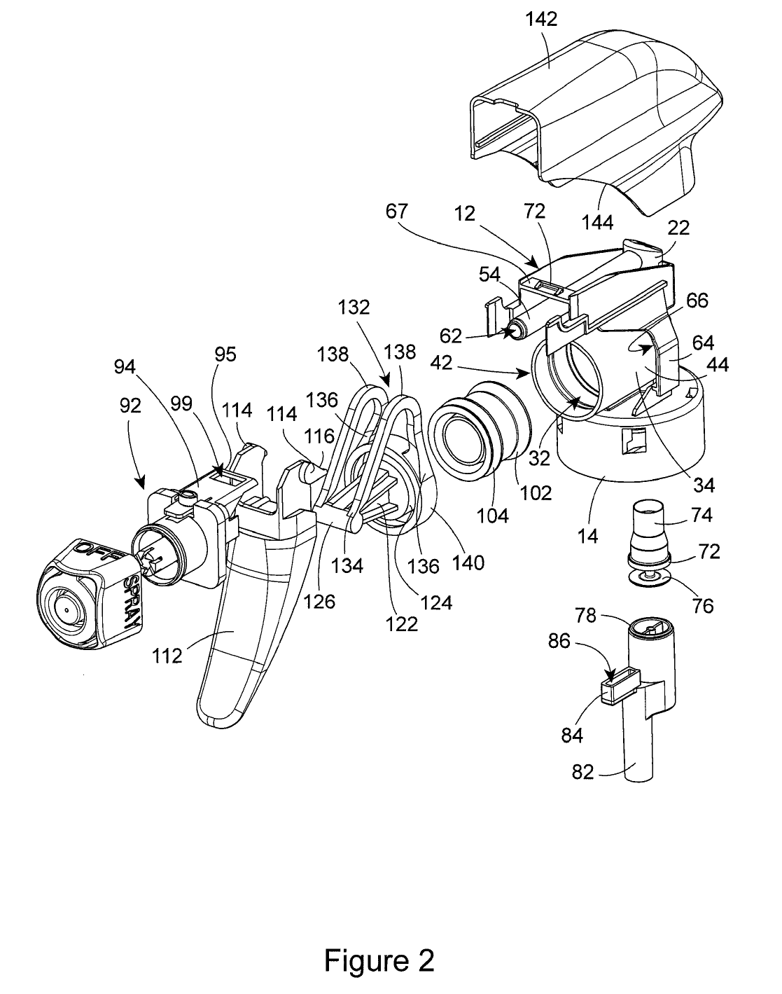

A nozzle assembly 92 is assembled to the sprayer housing 12 at the liquid outlet opening 62. The nozzle assembly 92 can have the construction of any conventional known nozzle assembly that produces the desired discharge pattern of liquid from the trigger sprayer. The nozzle assembly 92 has a rotatable nozzle cap that selectively changes the discharge from a “off” condition where the discharge is prevented, to a “spray” condition, a “stream” condition and/or a foaming discharge, as is conventional. FIGS. 9-11 show a slightly different embodiment of the nozzle assembly to be described with the component parts of the nozzle assembly being labeled with the same reference numbers used in describing the nozzle assembly 92 of FIGS. 1, 2, 5, and 7, but with the reference numbers being followed by a prime (′).

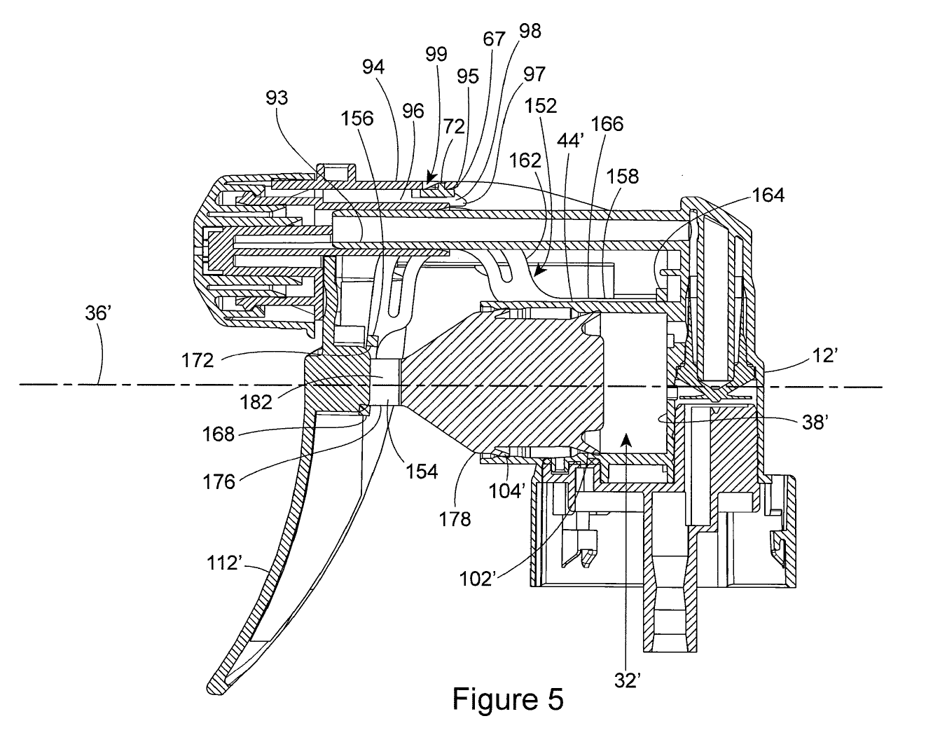

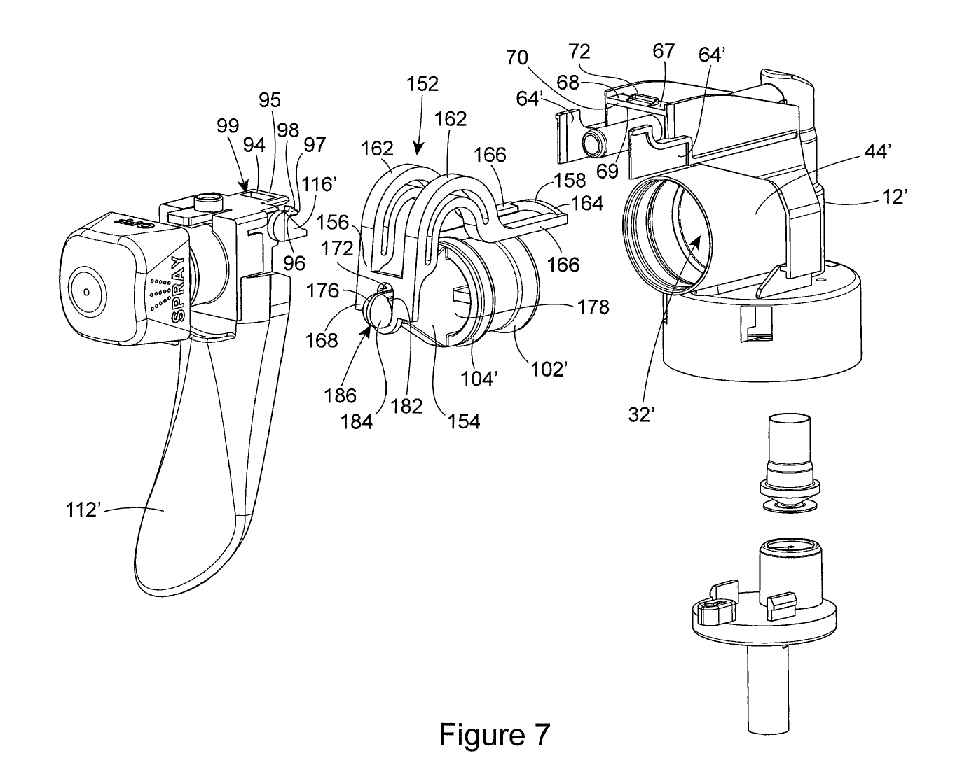

The novel construction of the nozzle assembly 92 includes a nozzle tube 93 that is dimensioned to fit in a tight sealing fit over the distal end of the liquid discharge tube 54 of the sprayer housing 12. The nozzle assembly tube 93 communicates the liquid discharge passage 58 of the sprayer housing 12 with the outlet orifice of the nozzle assembly 92 for discharging liquid pumped by the trigger sprayer from the nozzle assembly. The novel construction of the nozzle assembly 92 also includes a first resilient flange 94 that projects in the rearward direction from the nozzle assembly over the liquid discharge tube 54 of the sprayer housing. The first resilient flange 94 has a general rectangular configuration and projects from the nozzle assembly 92 to a distal end edge 95 of the flange. A second resilient flange 96 also projects rearwardly from the nozzle assembly 92. The second flange 96 could be a single flange, or could be a pair of second flanges 96. The second flange 96 is spaced below but extends substantially parallel alongside the first flange 94. The positioning of the second flange 96 can be seen in FIGS. 5 and 7, and in FIGS. 9-11. Only one second flange 96 is visible in FIGS. 5 and 7, but in alternate embodiments of the invention such as that shown in FIGS. 9-11, the nozzle assembly 92 could be provided with a pair of second flanges 96 that extend along the sides of the first flange 94. The second flange 96 extends from the nozzle assembly 92 to a distal end edge 97 of the second flange. The distal end edge 97 of the second flange has a hook configuration with a hook surface 98. The first flange 94 is formed with a catch hole 99. In assembling the nozzle assembly 92 to the sprayer housing 12, the nozzle assembly tube 93 is pushed over the liquid discharge tube 54 of the sprayer housing and moved in the rearward direction. The first flange 94 passes over the first surface 68 of the crossbar 67 and the second flange 96 passes beneath the second surface 69 of the crossbar. The nozzle assembly 92 is pushed onto the sprayer housing 12 until the first flange end 95 passes over the tapered surface of the catch 72 on the crossbar 67 and the resilience of the first flange 94 causes it to snap into engagement against the crossbar first surface 68 with the catch 72 being received in the first flange hole 99. Simultaneously, the second flange end 97 passes over the crossbar second surface 69 and the crossbar back edge 71. The resilience of the second flange 96 causes the hook surface 98 at the flange end 97 to snap over the back edge 71 of the crossbar. With the crossbar catch 72 received in the first flange hole 99 and the second flange hook surface 98 engaging across the crossbar back edge 71, the nozzle assembly 92 is securely attached to the sprayer housing 12. This attachment of the nozzle assembly 92 to the sprayer housing 12 assures that the nozzle assembly will not be dislodged from the sprayer housing when it is subjected to the increased velocity of liquid flow through the reduced diameter cross-section liquid discharge passage 58 of the sprayer housing.

A piston assembly comprising a liquid pump piston 102 and a vent piston 104 is mounted in the pump chamber 32 for reciprocating movement along the pump chamber axis 36. The pump piston 102 reciprocates between a charge position and a discharge position in the pump chamber 32. In the charge position, the pump piston 102 moves in a forward direction away from the pump chamber rear wall 38. This expands the interior of the pump chamber creating a vacuum in the chamber that draws liquid into the pump chamber, as is conventional. In the discharge position, the pump piston 102 moves in an opposite rearward direction into the pump chamber toward the pump chamber rear wall 38. This exerts a force on the liquid drawn into the pump chamber 32 and forces the liquid through the output opening 48, past the sleeve valve 74 and through the liquid discharge passage 58 and the liquid outlet opening 62. As the pump piston 102 reciprocates in the pump chamber 32 between the charge and discharge positions, the vent piston 104 reciprocates between a vent closed position where the vent piston 102 engages against the interior surface of the pump chamber wall 34, and a vent open position where the vent piston 104 is spaced inwardly from the interior of the pump chamber wall 34. In the vent open position of the vent piston 104, air from the exterior environment of the sprayer can pass through the pump chamber opening 42, past the vent piston 104 to the vent opening 26, and then through the spacing between the baffle 84 and the connector cap 14, through the vent baffle opening 86 and to the interior of the bottle connected to the trigger sprayer.

A manually operated trigger 112 is mounted on the sprayer housing 12 for opposite forward and rearward movement of the trigger relative to the sprayer housing. The trigger 112 has a pair of pivot posts 114 that project from opposite sides of the trigger and mount the trigger to the sprayer housing 12 for pivoting movement. A pair of flanges 116 project outwardly from the pivot posts 114 and limit the forward pivoting movement of the trigger 112 away from the sprayer housing 12. The construction of the trigger includes a finger engagement surface that is engaged by the fingers of a user's hand. Squeezing the trigger causes the trigger to pivot rearwardly toward the pump chamber 32, and releasing the squeezing force on the trigger allows the trigger to pivot forwardly away from the pump chamber. The engagement of the trigger flanges 116 with the sprayer housing side panels 64 stops the forward movement of the trigger 112.

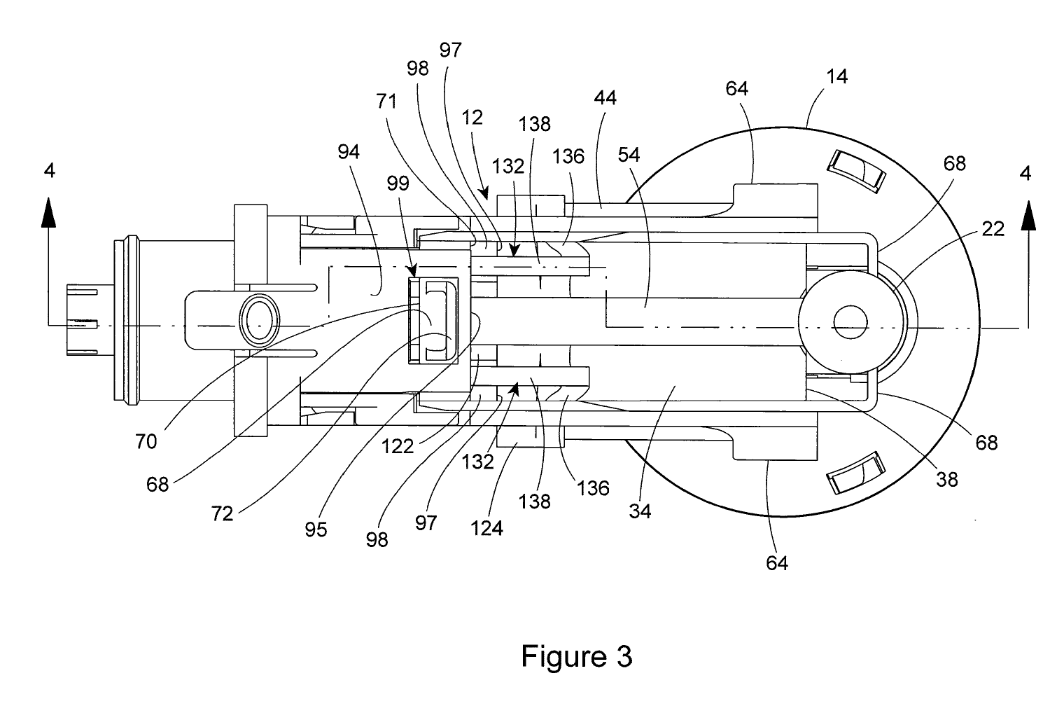

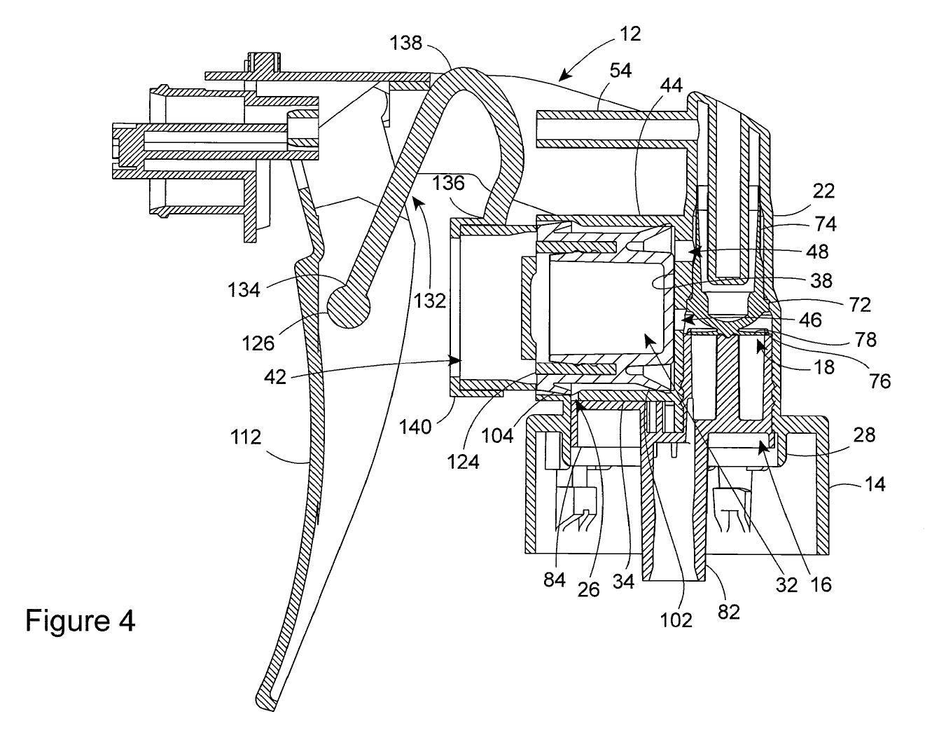

The trigger sprayer of FIGS. 1-4 includes a piston rod 122 that is operatively connected between the trigger 112 and the pump piston 102 and vent piston 104. The piston rod 122 has a length with a annular collar or ring 124 at one end of the rod length. The ring 124 is assembled to the piston assembly pump piston 102 and vent piston 104. The opposite end 126 of the piston rod 122 engages with and is operatively connected to the trigger 112.

The construction of the trigger sprayer also includes a pair of springs 132 that are formed integrally with the piston rod 122 and the ring 124. Together the springs 132, the piston rod 122, and the ring 124 are one, monolithic piece of plastic material, thereby reducing the number of separate component parts that go into the construction of the trigger sprayer. The pair of springs 132 each have a narrow, elongate length that extends between opposite proximal 134 and distal 136 ends of the springs. The intermediate portions 138 of the springs between the proximal ends 134 and distal ends 136 have the same bent or inverted U-shaped configurations. The spring proximal ends 134 are connected to the piston rod 122 at the first end or forward end 126 of the piston rod. From the proximal ends 134, the lengths of the springs angle upwardly away from the piston rod 22 and the pump chamber center axis 36 and then extend through the intermediate portions 138 of the springs. As the lengths of the springs extend through their U-shaped intermediate portions 138, the springs extend along opposite sides of the liquid discharge tube 54 and over the pump chamber wall 34. The springs then extend downwardly toward the pump chamber center axis 36 as the springs extend to their distal ends 136. The spring distal ends 136 are integrally connected to a circular collar or ring 140. The ring 140 is attached around the pump chamber 32 at the end opening 42 and thereby connects the spring distal ends 136 to the sprayer housing 12.

The inverted, U-shaped configurations of the springs 132 bias the piston rod 122 and the connected pump piston 102 and vent piston 104 outwardly away from the pump chamber rear wall 38. This biases the pump piston 102 toward its charge position relative to the pump chamber 32 and the sprayer housing 12. By manually squeezing the trigger 112, the spring proximal ends 134 move toward the spring distal ends 136, narrowing the U-shaped bend in the intermediate portions 138 of the springs. When the squeezing force on the trigger 112 is removed, the resiliency of the springs pushes the trigger 112 away from the pump chamber rear wall 38 and moves the pump piston 102 back to its charge position relative to the pump chamber 32.

A shroud 142 is attached over the sprayer housing 12 to provide an aesthetically pleasing appearance to the trigger sprayer. The shroud 142 has a lower edge 144 that is positioned below the U-shaped bends in the pair of springs 132. Thus, the shroud 142 protects the springs 132 from contact with portions of the hand or other objects exterior to the trigger sprayer when the trigger sprayer is being operated.

By providing the U-shaped springs 132 as an integral part of the pump piston rod 122 in lieu of the conventional coiled metal spring positioned in the pump chamber, the component parts of the trigger sprayer are reduced. This results in reduced manufacturing costs for the trigger sprayer.

In addition, by providing the pair of springs 132 as an integral part of the pump piston rod 122 and the ring 140, the springs are constructed of the same piece of material as the pump piston rod and ring. This eliminates the need for a separate metal coil spring and enables all of the component parts of the trigger sprayer to be constructed of a plastic material. With all the sprayer parts being constructed of plastic, the trigger sprayer can be recycled more economically after use.

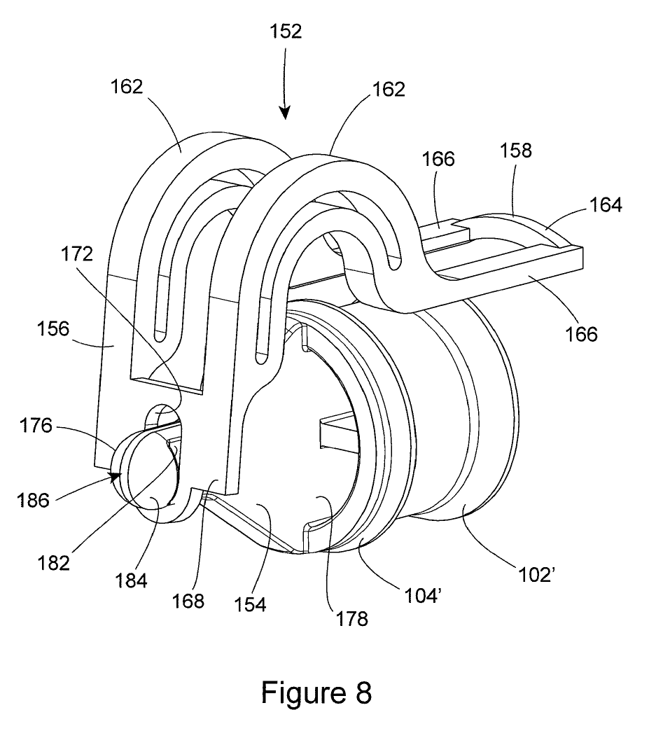

FIGS. 5-8 show a further embodiment of the trigger sprayer of the invention. In the embodiment of FIGS. 5-8, many of the component parts of the trigger sprayer are the same or are substantially the same as those present in the construction of the previously described embodiment of FIGS. 1-4. These structural components that are the same or substantially the same as those of the previously described embodiment are labeled by the same reference numbers used in labeling the component parts of the previously described embodiment, but the reference numbers are followed by a prime (′). Because these component parts are the same or substantially the same as the previously described embodiment, their structure and function will not be described again.

In the embodiment of FIGS. 5-8, the constructions of the spring assembly 152 and piston rod 154 differ from those of the previously described embodiment. As in the previously described embodiment, the spring assembly 52 is positioned outside of the pump chamber and is connected to the piston rod 154. However, the spring assembly 152 is a separate component part from that of the piston rod 154. Both the spring assembly 152 and the piston rod 154 are constructed of plastic.

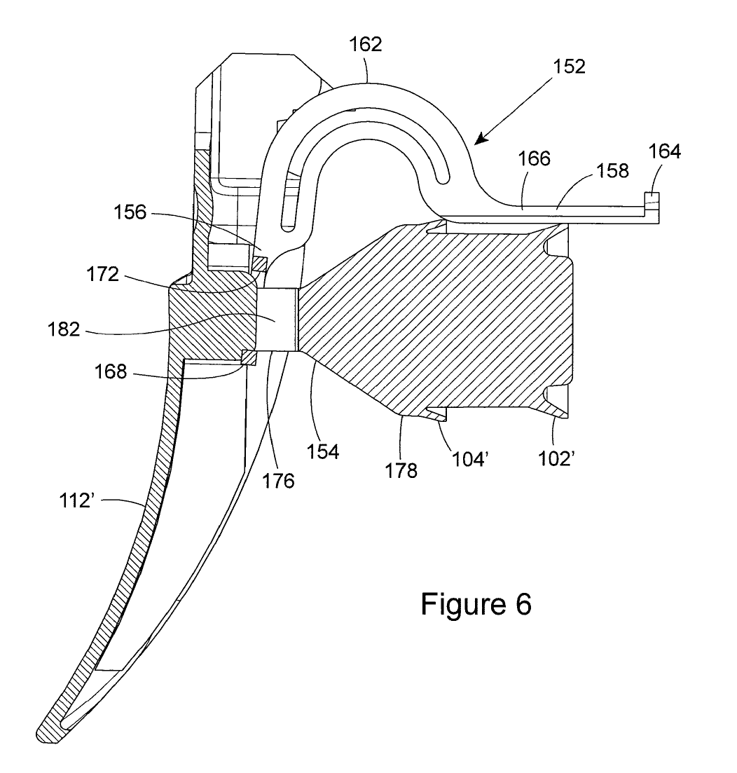

The spring assembly 152 is shown disassembled from the trigger sprayer in FIGS. 6, 7, and 8. The spring assembly 152 has a general curved or bent length that extends from a forward end 156 of the spring assembly to a rearward end 158 of the spring assembly. As in the previously described embodiment of the trigger sprayer, an intermediate portion of the spring assembly length is formed as a pair of curved or bent springs 162. These springs 162 have the general inverted U-shaped configuration of the previously describe embodiment. However, the springs 162 differ from that of the previously described embodiment in that they each are formed as a pair of curved leaves that are separate from each other. In alternate embodiments, the springs 162 could be formed as a pair of single leaf springs as in the previously described embodiment. Still further, the pair of springs 162 could be replaced by a single spring that extends along the curved length of the spring assembly 152.

The rearward ends 158 of the springs are joined to a curved bar 164. The curvature of the bar 164 is determined so that a bottom or radially inward surface of the curved bar 164 engages around a portion of the cylindrical exterior surface 44′ of the pump chamber. This curved bar 164 wedges between the exterior surface of the pump chamber 44′ and the pair of side walls 64′ of the sprayer housing in assembling the spring assembly 152 to the sprayer housing. From opposite ends of the curved bar 164, the spring assembly 152 includes a pair of parallel straight bars 166 that extend axially across the pump chamber exterior surface 44′ to the bent portions of the springs 162. The axial bars 166 engaging across the pump chamber exterior surface 44′ further stabilize the spring assembly 152 relative to the sprayer housing. From the ends of the axial bars 166 opposite the curved bar 164, the bent springs 162 first extend away from the pump chamber 32′ and then curve and extend downwardly to the spring forward end 156 positioned in front of the pump chamber. The spring forward end 156 is formed as a substantially flat panel that joins together the forward ends of the two bent portions of the springs 162. An opening 172 is provided in the panel 168. In the preferred embodiment, the opening 172 is a hole that passes completely through the front panel 168 and is centered relative to the pump chamber axis 36′. Still further, as shown in the drawing figures, the preferred configuration of the opening hole 172 is an oblong slot that is positioned vertically on the front panel 168.

The piston rod 154 has an axial length that extends between a forward end 176 and a rearward end 178 of the rod. In the illustrated embodiment, the piston rod rearward end 178 is formed integrally with the pump piston 102′ and the vent piston 104′. In alternate embodiments, the piston rod rearward end 178 could be assembled to the pump piston and vent piston as described in the previous embodiment. From the rearward end 178, the piston rod extends axially forward to the piston rod forward end 176. As the piston rod 154 extends forward, the rod length extends through a necked down portion 182 of the rod. The necked down portion 182 of the piston rod has a first circumferential dimension around the portion. The first circumferential dimension of the necked down portion 182 allows this portion of the piston rod to extend into the spring front panel opening 172. As shown in the drawing figures, the piston rod necked down portion 182 extends completely through the front panel opening 172 to the opposite side of the spring forward end 156 from the pump piston 102′ and vent piston 104′. Also as shown in the drawing figures, the relative dimensions of the piston rod necked down portion 182 and the oblong opening 172 in the spring forward end 156 allow the piston rod necked down portion 182 to slide through the elongated slot of the spring forward end opening 172 on flexing movement of the spring assembly 152. Extending forwardly along the length of the piston rod 154 from the necked down portion 182, the piston rod is provided with an enlarged portion or a knob 184 at the piston rod forward end 176. The knob 184 has a second circumferential dimension that is larger than the first circumferential dimension of the necked down portion 182. The second circumferential dimension of the knob 184 is larger than the width dimension of the oblong opening 172 in the spring forward end 156. This securely holds the spring forward end 156 to the piston rod forward end 176. The piston rod forward end 176 is provided with a vertical groove 186 that extends into the forward end. The groove 186 in the piston rod forward end 176 is provided to make the piston rod forward end compressible. This enables the compression of the piston rod forward end 176 when inserting the forward end through the opening 172 in the spring forward end 156. Once the knob 154 of the piston rod forward end 176 is inserted through the spring opening 172, the resilience of the plastic material of the piston rod 154 allows the knob 184 to expand in width to a larger width dimension than the opening 172 in the spring forward end 156. This secures the spring forward end 156 to the piston rod forward end 176 with the piston rod forward end 176 extending beyond the spring front panel 168 and operatively engaging with the trigger 112′.

The inverted, U-shaped configurations of the bent portions 162 of the springs 152 bias the piston rod 154 and the connected pump piston 102′ and vent piston 104′ outwardly away from the pump chamber rear wall 38′. This biases the pump piston 102′ toward its charge position relative to the pump chamber 32′ and the sprayer housing 12′. The bias of the spring assembly 152 is slightly compressed between the engagement of the spring rearward end 158 with the sprayer housing 12′ and the engagement of the spring forward end 156 with the trigger 112′. This further secures the spring assembly 152 in place on the trigger sprayer. By manually squeezing the trigger 112′, the spring forward end 156 is moved toward the spring rearward end 158, narrowing the U-shaped bends 162 in the springs. When the squeezing force on the trigger 112 is removed, the resiliency of the spring assembly 152 pushes the trigger 112′ away from the pump chamber rear wall 38′ and moves the pump piston 102′ back to its charge position relative to the pump chamber 32′. As the length of the spring assembly 152 is shortened and lengthened as the trigger 112′ is manipulated, the oblong opening 172 through the spring forward end 156 allows the piston rod forward end 176 to slide relative to the spring.

Thus, the novel construction of the sprayer housing includes a reduced cross-section area dimension of the liquid discharge passage that increases the velocity of liquid pumped through the liquid discharge tube. This increased velocity of liquid discharge from the sprayer housing provides the quick and forceful ejection of liquid from the sprayer housing desired by consumers.

In addition, by providing the novel construction of the crossbar on the sprayer housing combined with the flanges that project from the nozzle assembly and engage over opposite surfaces of the crossbar to securely attach the nozzle assembly to the sprayer housing, the potential problem of the quick and forceful ejection of liquid from the sprayer housing potentially pushing off the nozzle assembly from the sprayer housing is eliminated.

Although the trigger sprayer of the invention has been described above by reference to specific embodiments, it should be understood that modifications and variations could be made to the trigger sprayer without departing from the intended scope of the following claims.

1) A manually operated trigger sprayer comprising:
a sprayer housing having a pump chamber in the sprayer housing, a liquid inlet opening on the sprayer housing, a liquid supply passage extending through the sprayer housing communicating the liquid inlet opening with the pump chamber, a liquid outlet opening on the sprayer housing, a liquid discharge passage extending through the sprayer housing communicating the pump chamber with the liquid outlet opening, the sprayer housing having a discharge tube with a portion of the liquid discharge passage extending through the liquid discharge tube to the liquid outlet opening at a distal end of the liquid discharge tube, and the sprayer housing having a catch adjacent the distal end of the liquid discharge tube;
a pump piston mounted in the pump chamber for reciprocating movement of the pump piston between charge and discharge positions of the pump piston relative to the pump chamber;
a trigger mounted on the sprayer housing and operatively connected to the pump piston for movement of the trigger between a charge position of the trigger relative to the sprayer housing when the pump piston is in the charge position of the pump piston relative to the pump chamber, and a discharge position of the trigger relative to the sprayer housing when the pump piston is in the discharge position of the pump piston relative to the pump chamber; and,
a nozzle assembly mounted on the sprayer housing, the nozzle assembly having a nozzle tube that engages over the liquid discharge tube of the sprayer housing in mounting the nozzle assembly to the sprayer housing, and the nozzle assembly having a resilient flange that engages over the catch of the sprayer housing in securing the nozzle assembly to the sprayer housing.

2) The trigger sprayer of claim 1, further comprising:
the nozzle assembly flange being a resilient, thin flange that is spaced from the nozzle assembly tube and has a length that extends along the nozzle assembly tube and along a portion of the sprayer housing liquid discharge tube adjacent the nozzle assembly tube.

3) The trigger sprayer of claim 2, further comprising:
the nozzle assembly flange having a hole in the flange that receives the sprayer housing catch in attaching the nozzle assembly to the sprayer housing.

4) The trigger sprayer of claim 3, further comprising:
a shroud mounted on the sprayer housing, the shroud having a forward portion that extends over and covers the nozzle assembly flange and the nozzle assembly flange hole.

5) The trigger sprayer of claim 1, further comprising:
the sprayer housing having a pair of side walls that extend along opposite sides of the liquid discharge tube of the sprayer housing, and the catch being connected to the pair of side walls.

6) The trigger sprayer of claim 5, further comprising:
the sprayer housing side walls being spaced from opposite sides of the sprayer housing liquid discharge tube; and,
a resilient crossbar extending between the pair of side walls, the crossbar being spaced from and extending across the liquid discharge tube of the sprayer housing, and the catch being on the crossbar.

7) The trigger sprayer of claim 6, further comprising:
the crossbar being a thin, resilient strip with opposite first and second surfaces, the catch being on the first surface of the crossbar, and the second surface of the crossbar facing toward and being spaced from the liquid discharge tube of the sprayer housing.

8) A manually operated trigger sprayer comprising:
a sprayer housing having a pump chamber in the sprayer housing, a liquid inlet opening on the sprayer housing, a liquid supply passage extending through the sprayer housing communicating the liquid inlet opening with the pump chamber, a liquid outlet opening on the sprayer housing, a liquid discharge passage extending through the sprayer housing communicating the liquid outlet opening with the pump chamber, the sprayer housing having a liquid discharge tube containing the liquid discharge passage and having the liquid outlet opening at a distal end of the liquid discharge tube, and a crossbar on the sprayer housing;
a pump piston mounted in the pump chamber for reciprocating movement of the pump piston between charge and discharge positions of the pump piston relative to the pump chamber;
a trigger mounted on the sprayer housing and operatively connected to the pump piston for movement of the trigger between charge and discharge positions of the trigger relative to the sprayer housing with the pump piston being moved between the respective charge and discharge positions of the pump piston relative to the pump chamber; and,
a nozzle assembly mounted on the sprayer housing and communicating with the liquid discharge passage through the liquid outlet opening of the sprayer housing, the nozzle assembly having a pair of first and second resilient flanges that are spaced from each other and engage over opposite sides of the sprayer housing crossbar with the crossbar positioned between the pair of resilient flanges in securing the nozzle assembly to the sprayer housing.

9) The trigger sprayer of claim 8, further comprising:
the sprayer housing having a pair of side walls that extend along opposite sides of the liquid discharge tube of the sprayer housing, and the crossbar being connected to the pair of side walls.

10) The trigger sprayer of claim 9, further comprising:
the sprayer housing side walls being spaced from opposite sides of the sprayer housing liquid discharge tube;
the crossbar extending between the pair of side walls, the crossbar being spaced from and extending across the liquid discharge tube of the sprayer housing; and
a catch projecting from the crossbar.

11) The trigger sprayer of claim 10, further comprising:
the crossbar being a thin, resilient strip with opposite first and second surfaces, the catch being on the first surface of the crossbar, and the second surface of the crossbar facing toward and being spaced from the liquid discharge tube of the sprayer housing.

12) The trigger sprayer of claim 8, further comprising:
the crossbar being a thin, resilient strip with opposite first and second surfaces and opposite forward and rearward edges; and,
the pair of resilient flanges including a first flange that extends across the forward edge of the crossbar and engages across the first surface of the crossbar, and a second flange that extends across the front edge of the crossbar, engages across the second surface of the crossbar, and engages the back edge of the crossbar.

13) The trigger sprayer of claim 12, further comprising:
the second flange projecting from the nozzle assembly to a distal end of the second flange, and the second flange distal end having a hook configuration that engages across the back edge of the crossbar.

14) The trigger sprayer of claim 12, further comprising:
the crossbar having a catch that projects outwardly from the crossbar first surface; and,
the first flange extending from the nozzle assembly to a distal end of the first flange, the first flange having a hole through the first flange adjacent the distal end of the first flange, and the catch on the crossbar extending into the hole in the first flange.

15) The trigger sprayer of claim 14, further comprising:
a shroud mounted on the sprayer housing, the shroud having a forward portion that extends over the first flange and covers the hole in the first flange from view.

16) A manually operated trigger sprayer comprising:
a sprayer housing having a pump chamber in the sprayer housing, a liquid inlet opening on the sprayer housing, a liquid supply passage extending through the sprayer housing communicating the liquid inlet opening with the pump chamber, a liquid outlet opening on the sprayer housing, a liquid discharge passage extending through the sprayer housing communicating the liquid outlet opening with the pump chamber, and a resilient crossbar on the sprayer housing spaced from the liquid discharge passage and extending across the liquid discharge passage, the crossbar having a surface with a catch projecting from the crossbar surface;
a pump piston mounted in the pump chamber for reciprocating movement of the pump piston between charge and discharge positions of the pump piston relative to the pump chamber;
a trigger mounted on the sprayer housing and operatively connected to the pump piston for movement of the trigger between charge and discharge positions of the trigger relative to the sprayer housing, the trigger moving to the charge position of the trigger relative to the sprayer housing with the pump piston moving to the charge position of the pump piston relative to the pump chamber, and the trigger moving to the discharge position of the trigger relative to the pump housing with the pump piston moving to the discharge position of the pump piston relative to the pump chamber; and,
a nozzle assembly mounted on the sprayer housing and communicating with the liquid discharge passage, the nozzle assembly having a pair of resilient first and second flanges that project from the nozzle assembly along one side of the sprayer housing liquid discharge passage, the first flange of the pair of flanges having a hole, and the pair of flanges extending across opposite sides of the sprayer housing crossbar with the catch of the sprayer housing crossbar engaging in the hole in the nozzle assembly first flange to securely hold the nozzle assembly to the sprayer housing.

17) The trigger sprayer of claim 16, further comprising:
the sprayer housing having a pair of side walls that are spaced from and extend along opposite sides of the liquid discharge passage in the sprayer housing; and,
the crossbar being connected to the pair of sprayer housing side walls and being spaced from the sprayer housing liquid discharge passage.

18) The trigger sprayer of claim 17, further comprising:
the second flange of the nozzle assembly extending between the sprayer housing crossbar and the sprayer housing liquid discharge passage.

19) The trigger sprayer of claim 17, further comprising:
the crossbar being formed as a thin, resilient strip with opposite surfaces that extend between the pair of sprayer housing side walls, and with opposite front and back edges that extend between the pair of sprayer housing side walls; and,
the nozzle assembly first flange extending across the front edge and across the first surface of the crossbar, and the nozzle assembly second flange extending across the front edge, across the second surface of the crossbar, and across the back edge of the crossbar.

20) The trigger sprayer of claim 19, further comprising:
the nozzle assembly second flange having a hook formed thereon that engages across the back edge of the sprayer housing crossbar.
